(19) United States
(12) Patent Application Publication
(10) Pub. No.: US 2013/0213590 A1
(43) Pub. Date: Aug. 22, 2013

(54) Magnetic Screen Device for Recreational Use with Vehicles and Method of Use

(71) Applicant: Roger Apostolico, Orlando, FL (US)

(72) Inventor: Roger Apostolico, Orlando, FL (US)

(21) Appl. No.: 13/402,317

(22) Filed: Feb. 22, 2012

(51) Int. Cl. B60J 3/02

(52) U.S. Cl. 160/370.21; 160/405

(57) ABSTRACT

The present invention provides a new and useful magnetic screen device for recreational use with vehicles and a method of use. This invention is believed to be useful by offering a device which is removeably attached to a vehicle over openings or windows thereby allowing the free flow of air throughout the interior cabin of the vehicle. While in place, this device keeps particulate matter or pests from entering the car, and keeps the interior of the car from overheating in the sun. This device does not require installation, is easy to wash and store after use. The device also provides a surface upon which a decorative element can be printed—for example a team logo or mascot. It is intended that this device not be used when the vehicle is in motion.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### TECHNICAL FIELD

The present invention is in the technical field of screen devices. More particularly, the present invention is in the technical field of screen devices for vehicles. More particularly, the present invention is in the technical field of magnetic screen devices for vehicles.

### BACKGROUND OF THE INVENTION

Recreational use of vehicles, particularly the automobile, is an integral part of the American heritage and culture. With the advent of the affordable automobile, middle class families and others found a new way to vacation, explore the country and otherwise entertain themselves. Referring to the Model-T, Henry Ford said that with such an automobile each man would “enjoy with his family the blessing of hours of pleasure in God's great open spaces.”Americans quickly became vacation and automobile enthusiasts.

The tradition continues today. One doesn't have to look far to see cars cruising on the beach, festive tailgate parties held before sporting events, campers in RVs, recreational off-road adventurers, and even a resurgence of nostalgic road trips, drive-in theaters and the like.

Currently there is a need for a magnetic screen device for recreational use with vehicles. While partaking of the aforementioned activities it is common persons desire to park the car for a period of time. In order to keep the car interior from overheating while parked, users often open or “crack” the windows. In the alternative, some drivers keep the windows closed and turn on the interior air conditioner to maintain the interior environment at a comfortable temperature—perhaps for occupants inside. Both of these approaches have inherent problems.

Oftentimes, cracking or opening a car window allows particulate matter or pests to enter. If one should instead leave the windows sealed and turn on the air conditioner, the car must remain on thereby wasting gas and releasing by-products of combustion into the environment.

In the applicant's experience there is a deficiency in the existing and prior art wherein there currently are no removeably attached screen devices for recreational use with vehicles, that can be used over open windows, allows the free flow of air throughout the vehicle, does not require installation, keeps particulate matter or pests from entering the vehicle, provides a surface upon which a decorative element can be printed, is washable, and is easy to store when not in use. The device of the present invention is believed to accomplish all of the foregoing objectives.

Although there exists a variety of sun shades for cars on the market, they are indicated to be used when the automobile windows are raised. These sun shades on the market are usually constructed from a roll of tinted film and come in a hard case with a spring wound retracting mechanism. These mechanisms are subject to breakage, are attached to the window by means of suction cups and require some installation. Further, they attach onto the interior side of closed windows and therefore do not allow the passage of air into and through the cabin of the car. Finally, the majority of these visors are not permeable.

There also exists a number of window cling shades for vehicles. Like the aforementioned sun shades, window clings require the windows to be closed and do not address the objectives of the present invention.

Both of the aforementioned existing apparatus in the field are indicated to be used by passengers who desire to block bright sunlight, and are often shown used when the vehicle is in motion. These devices focus primarily on the control or attenuation of bright sunlight and fail to address the need for a permeable screen to be used while the vehicle is parked, that keeps particulate matter and pests from entering the car via an open window, and allows air to flow through the vehicle compartment in order to reduce overheating of the vehicle interior.

In the applicant's experience there is a need for a screen device which: i) is removeably attached to a vehicle, ii) can be used over open windows, iii) allows for the free flow of air throughout the vehicle, iv) does not require installation, v) keeps particulate matter or pests from entering the vehicle, vi) provides a surface upon which a decorative element can be printed, vii) is washable, and viii) is easy to store when not in use. The device of the present invention is believed to accomplish all of the foregoing objectives.

### SUMMARY OF THE INVENTION

The present invention provides a new and useful magnetic screen device for recreational use with vehicles and a method of use. This invention is believed to be useful by offering a device which is removeably attached to a vehicle over openings or windows thereby allowing the free flow of air throughout the interior cabin of the vehicle. While in place, this device keeps particulate matter or pests from entering the car, and keeps the interior of the car from overheating in the sun. This device does not require installation, is easy to wash and store after use. The device also provides a surface upon which a decorative element can be printed—for example a team logo or mascot. It is intended that this device not be used when the vehicle is in motion.

Current devices are primarily sun shades which serve to attenuate the brightness of sunlight perceived by a passenger. These are often shown to be in use while the car is in motion and require the window to be closed. The bulk of the current art requires installation and come in rigid plastic tubes with a spring retraction mechanism.

In one of its basic embodiments the present invention comprises a permeable membrane having a plurality of perforations throughout and cut in a two dimensional geometric shape that corresponds to a window or opening on a vehicle. This membrane is surrounded at the perimeter with a binding that is stitched to the membrane using a primary seam. Along the binding are a plurality of contact pads, approximately evenly spaced, and each attached to the device with a secondary seam. The secondary seam creates a closed geometric shape and defines a pocket or interior therein. Within the interior spaces of the contact pads are magnets which create a magnetic force used to removeably attach the device to a car.

When the device is in use, the user places the subject vehicle in park, thereby immobilizing the vehicle. Next, the user opens a window or other opening on the vehicle. The user retrieves the magnetic screen device, and unfurls it. Finally, the user attaches the device to the metallic frame surrounding the opening or window on the vehicle using the magnets enclosed in the device.

Thus the present invention is believed to provide a new and useful screen device which: i) is removeably attached to a vehicle, ii) can be used over open windows, iii) allows for the free flow of air throughout the vehicle, iv) does not require installation, v) keeps particulate matter or pests from entering the vehicle, vi) provides a surface upon which a decorative element can be printed, vii) is washable, and viii) is easy to store when not in use. The device of the present invention is believed to accomplish all of the foregoing objectives.

Further features and objectives of the present invention will become apparent from the following detailed descriptions and the accompanying drawings.

### BRIEF DESCRIPTION OF THE DRAWINGS

FIG. 1 is a front view of the device according to the present invention;

FIG. 2 is an exploded view of a portion of the device according to the present invention and shows the membrane being assembled into the binding;

FIG. 3 is an exploded view of a portion of the device according to the present invention and shows the binding open to reveal the orientation of interior components; and

FIG. 4 is a view of an embodiment of the present invention being used in its environment.

### DETAILED DESCRIPTION OF THE INVENTION

As described above, the present invention provides a new and useful magnetic screen device for recreational use with vehicles which is removeably attached to a vehicle, can be used over open windows, allows for the free flow of air throughout the vehicle, does not require installation, keeps particulate matter or pests from entering the vehicle, provides a surface upon which a decorative element can be printed, is washable and is easy to store when not in use. The following description and accompanying drawings disclose at least one version of such a device.

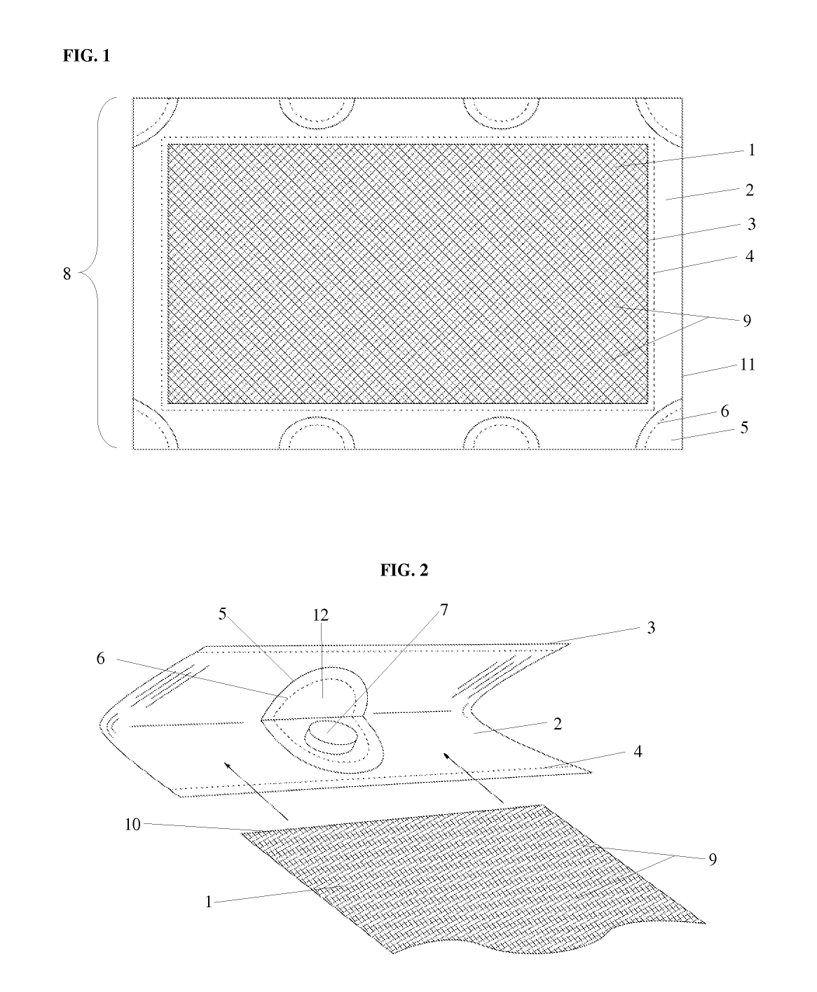

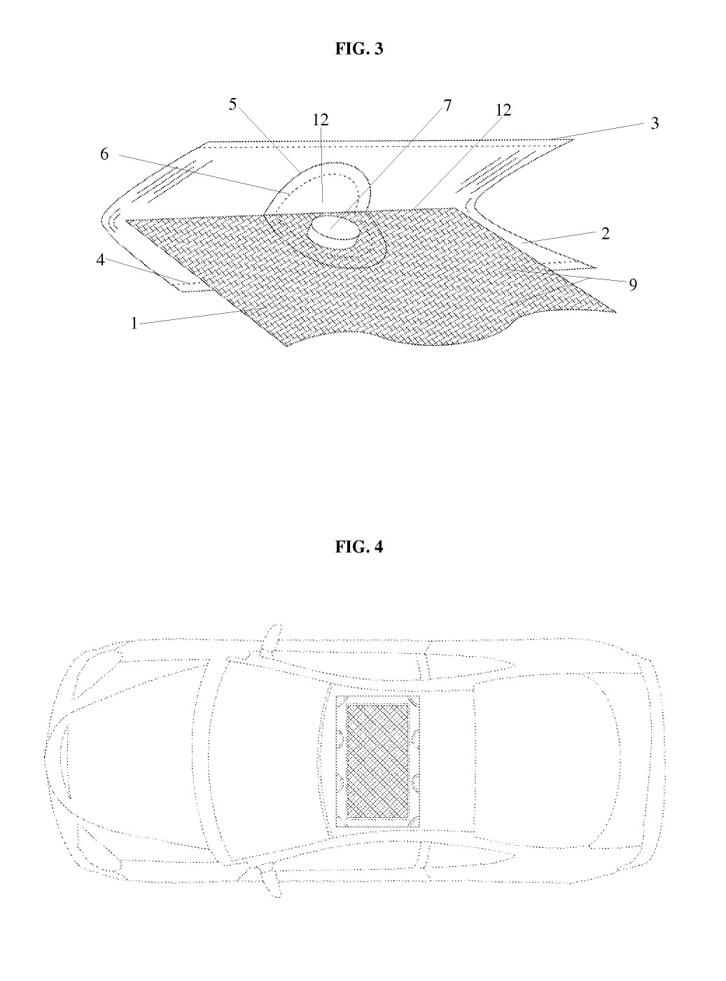

Referring now to the invention in more detail, in FIG. 1, FIG. 2, and FIG. 3 there is shown a magnetic screen device for recreational use with vehicles shown generally 8. The device comprises a permeable membrane 1, said permeable membrane 1 having a plurality of perforations 9 evenly dispersed throughout, and is cut in a two-dimensional geometric shape having a plurality of edges 10 creating a perimeter. Each edge 10 has a dimension approximately four inches longer than the corresponding dimension of a vehicle window or opening intended to be covered. The membrane 1 is composed of net, screen, perforated vinyl, nylon or an equivalent and can be colored or printed with a decorative element. A binding 2 surrounds the perimeter of the invention 8 and wraps around the edges of the membrane 10 thereby forming an interior boundary 3 and an exterior boundary 11. Said binding is composed of a wear-resistant material or fabric, such as nylon or equivalent. A primary seam 4 attaches the binding 2 to the permeable membrane 1 approximately parallel to and along the interior boundary 3 of the binding 2. The primary seam 4 can be a glue, stitch, or an equivalent penetrating through the binding 2 and permeable membrane 1 thereby fixing them together. A plurality of contact pads 5 are approximately evenly spaced on the binding 2 and along the perimeter of the device 8. Said pads 5 are made of a non-abrasive material such as felt, rubber, or foam. A plurality of secondary seams 6 outline and attach the contact pads 5 along the binding 2 defining an interior space therein. The secondary seams 6 can be made of a glue, stitch, or an equivalent penetrating the binding 2 and membrane 1. A plurality of magnets 7 are distributed approximately evenly among and contained within each of the interior spaces defined by the secondary seam 6. The magnets 7 thereby exert a magnetic force used for the purpose of removeably attaching the device 8 to a vehicle.

The dimensions of the device 8 can be any size—as dictated by the corresponding vehicle opening or window desired to be covered. It is envisioned that one embodiment will have edges 10 approximately four inches longer than the corresponding dimension of the window to be covered. For example, a 2008 Chrysler PT Cruiser has a standard sunroof that measures nineteen inches long and thirty two inches wide. Therefore the magnetic screen device 8 will measure approximately twenty three inches long and thirty six inches wide.

One embodiment of the invention does not have contact pads 5. Instead, a plurality of secondary seams 6 creates enclosed geometric shapes or pockets along the binding 2 and defining an interior space therein. In this embodiment a plurality of magnets 7 are evenly disbursed and held within the interior spaces defined by each secondary seam 6.

To use the device 8, the user places the target vehicle in park. Next, the user opens a window or other opening on the vehicle. Once stationary, the user retrieves the magnetic screen device 8, and unfurls it. Finally, the user attaches the device 8 to the metallic frame surrounding the opening or window on the vehicle using the magnets 7 enclosed in the device 8.

Referring now to FIG. 4, the device 8 is shown in its environment when in use. This embodiment of the present invention is attached to cover an open sunroof.

One embodiment of the present invention provides for the placement or printing of a decorative element on the surface of the membrane 1—for example a team logo or mascot.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A magnetic screen device for recreational use with vehicles comprising:
a) a permeable membrane,
said permeable membrane having a plurality of perforations evenly dispersed throughout, and is cut in a two-dimensional geometric shape having a plurality of edges creating a perimeter, each edge having a dimension approximately four inches longer than the corresponding dimension of a vehicle window or opening intended to be covered,
the membrane is composed of net, screen, perforated vinyl, nylon or an equivalent and can be colored or printed with a decorative element;
b) a binding,
said binding surrounding and wrapping around the edges of the membrane thereby forming an interior boundary,
the binding is composed of a wear-resistant material or fabric, such as nylon or equivalent;
c) a primary seam,
said primary seam attaching the binding to the permeable membrane approximately parallel to and along the interior boundary of the binding,
the primary seam can be a glue, stitch, or an equivalent penetrating through the binding and permeable membrane thereby fixing them together;
d) a plurality of contact pads,
said pads are approximately evenly spaced on the binding and along the perimeter of the device,
the pads are made of a non-abrasive material such as felt or foam;
e) a plurality of secondary seams,
said secondary seams outline and attaches the contact pads along the binding defining an interior space therein,
the secondary seam can be a glue, stitch, or an equivalent penetrating the binding and membrane; and
f) a plurality of magnets,
said magnets are distributed approximately evenly among and contained within each of the interior spaces defined by the secondary seam,
the magnets thereby exerting a magnetic force used for the purpose of removeably attaching the device to a vehicle.

2. A magnetic screen device comprising:
a) a permeable membrane having a plurality of perforations evenly dispersed throughout and is cut into a two-dimensional geometric shape having a plurality of edges creating a perimeter;
b) a binding surrounding and wrapping around the edges of the membrane thereby forming an interior boundary;
c) a primary seam attaching the binding to the permeable membrane approximately parallel to and along the interior boundary of the binding,
d) a plurality of secondary seams creating enclosed geometric shapes or pockets along the binding and defining an interior space therein; and
e) a plurality of magnets evenly disbursed and held within the interior spaces defined by each secondary seam.

3. The permeable membrane as in claim 2, wherein each edge has a dimension that is longer than the corresponding dimension of a vehicle window or opening intended to be covered.

4. The permeable membrane as in claim 2, wherein the membrane is made of net, screen, perforated vinyl, nylon or an equivalent.

5. The permeable membrane as in claim 2, wherein the membrane is colored or printed with a decorative element.

6. The binding as in claim 2, wherein the binding is composed of a wear-resistant material or fabric, such as nylon or an equivalent.

7. The primary seam as in claim 2 comprises glue, a stitch, or an equivalent penetrating through the binding and permeable membrane thereby fixing them together.

8. The secondary seams as in claim 2 can comprise glue, a stitch, or an equivalent penetrating the binding and membrane thereby fixing them together.

9. The device as in claim 2, further comprising a plurality of contact pads attached to the binding at approximately evenly spaced intervals along the perimeter of the device, and attached to the device by the secondary seam.

10. The device as in claim 9, wherein the pads are comprised of a non-abrasive material different than that of the binding means, such as felt or foam.

11. A method of use for the magnetic screen device comprising:
a) placing the target vehicle in park;
b) opening a window or other opening on the vehicle;
c) retrieving the magnetic screen device;
d) unfurling the device; and
e) attaching the device to the metallic frame surrounding the opening or window on the vehicle using the magnets enclosed in the device.
